(19) United States
(12) Patent Application Publication
(10) Pub. No.: US 2014/0078146 A1
(43) Pub. Date: Mar. 20, 2014

(54) FLIGHT OBSTACLE EXTRACTION DEVICE, FLIGHT OBSTACLE EXTRACTION METHOD, AND RECORDING MEDIUM

(71) Applicants: Toshiyuki Kamiya, Osaka (JP); Hirokazu Koizumi, Osaka (JP)

(72) Inventors: Toshiyuki Kamiya, Osaka (JP); Hirokazu Koizumi, Osaka (JP)

(73) Assignee: Nec System Technologies, Ltd., Osaka (JP)

(21) Appl. No.: 13/148,837

(22) PCT Filed: Feb. 8, 2010
(86) PCT No.: PCT/JP2010/051785

§ 371 Date: Aug. 10, 2011

(30) Foreign Application Priority Data
Feb. 20, 2009 (JP) 2009-038650

(51) Int. Cl. G06T 15/08

(52) U.S. Cl. CPC G06T 15/08
USPC 345/427

(57) ABSTRACT

Provided is a flight obstacle extraction device, a flight obstacle extraction method, and a recording medium which attain the detailed extraction of flight obstacles with fewer man-hours. An altitude information acquisition unit (20) receives a plurality of images imaging a predetermined area from a plurality of different positions, and generates digital surface model data expressing the surface of the given area with three-dimensional coordinates. An obstacle candidate computation unit (50), on the basis of generated digital surface model data, extracts candidates for flight obstacles which may conflict with a flight restriction surface from the images. A flight obstacle determination unit (60) detects flight obstacles conflicting with the flight restriction surface from among the candidates for flight obstacles extracted by the obstacle candidate computation unit (50). s for flight obstacles.

### TECHNICAL FIELD

The present invention relates to a flight obstacle extraction device, a flight obstacle extraction method, and a recording medium. More particularly, the present invention relates to a flight obstacle extraction device, a flight obstacle extraction method, and a recording medium able to extract a flight obstacle from a restriction surface and the altitudes of building structures around an airport.

### BACKGROUND ART

Space restrictions are defined around airports in order to ensure the safety of aircraft airspace. Such space restrictions are called the airport restriction surface (hereinafter also simply called the “restriction surface”). Since tall building structures, etc. dear an airport will become an obstruction to the safe flight of aircraft if present, a restriction surface is defined with the goal of prohibiting the construction, etc. of such building structures near an airport. Additionally, the establishment of a building structure that protrudes onto a restriction surface is prohibited by aviation law.

A flight restriction surface check device is described in Patent Literature 1 as an example of technology that checks such conflicts between an airport's restriction surface and building structures around the airport.

FIG. 8 is a block diagram that functionally illustrates a flight restriction surface check device described in Patent Literature 1. A flight restriction surface check device 200 is provided with a building structure altitude—restriction surface altitude computation unit 70 and a clearance check unit 80. If altitude information indicating the planar positions and altitudes of building structures around an airport are input, the building structure altitude—restriction surface altitude computation unit 70 of the flight restriction surface check device 200 calculates the absolute altitude of a building structure and the altitude of the restriction surface at that planar position. Then, the clearance check unit 80 compares the absolute altitude of the building structure and the altitude of the restriction surface, checks conflicts between the building structure and the restriction surface, and outputs a clearance check result.

### CITATION LIST

### Patent Literature

Patent Literature 1: Unexamined Japanese Patent Application KOKAI Publication No. 2002-32421

### DISCLOSURE OF INVENTION

### Technical Problem

However, the flight restriction surface check device 200 cannot judge the trespass conditions until building structure altitude information is input, even in the case where there are clearly no building structures that trespass the restriction surface. Consequently, the operator must survey the altitudes of all building structures inside a target range, and input altitude information indicating those altitudes, etc. into the flight restriction surface check device 200. For this reason, there has been a problem in that checking conflicts between building structures and a restriction surface costs many man-hours.

Also, pre-existing altitude data input into the flight restriction surface check device 200 ordinarily does not include detailed altitude information such as lightning rods and other rooftop structures. For this reason, there has been a problem in that extraction of flight obstacles cannot be precisely conducted with the flight restriction surface check device 200.

Furthermore, the flight restriction surface check device 200 merely determines whether or not individual building structures conflict with the restriction surface on the basis of input data. For example, in the case where a building structure that exceeds the restriction surface is built due to the willfulness or negligence, etc. of the builders, extracting this as a flight obstacle has been practically impossible. In other words, there has been a problem in that the flight restriction surface check device 200 is insufficient as a technology used in order to determine whether or not building structures around an airport conflict with a restriction surface in order to ensure aircraft safety.

The present invention, being devised in light of the above-described circumstances, takes as an object to provide a flight obstacle extraction device, a flight obstacle extraction method, and a recording medium able to extract flight obstacles in detail with few man-hours.

### Solution to Problem

In order to achieve the above object, a flight obstacle extraction device in accordance with a first aspect of the present invention is provided with stereo matching processing means for taking a plurality of images imaging a given area from a plurality of different positions as input, and generating digital surface model data expressing the surface of the given area in three-dimensional coordinates, extracting means for extracting candidates for flight obstacles that could conflict with a flight restriction surface from the images on the basis of the digital surface model data generated by the stereo matching processing means, and detecting means for detecting the flight obstacles that conflict with the flight restriction surface from among the candidates for flight obstacles extracted by the obstacle candidate extracting means.

A flight obstacle extraction method in accordance with a second aspect of the present invention is a flight obstacle extraction method conducted by a flight obstacle extraction device that detects flight obstacles that could conflict with a flight restriction, surface, and is provided with a stereo matching processing step for taking a plurality of images imaging a given area from a plurality of different positions as input, and generating digital surface model data expressing the surface of the given area in three-dimensional coordinates, an extracting step for extracting candidates for flight obstacles that could conflict with a flight restriction surface from the images on the basis of the digital surface model data generated by the stereo matching processing step, and a detecting step for detecting the flight obstacles that conflict with the flight restriction surface from among the candidates for flight obstacles extracted by the obstacle candidate extracting step.

A recording medium in accordance with a third aspect of the present invention is a computer-readable recording medium having recorded thereon a program for causing a computer to execute a stereo matching processing operation for taking a plurality of images imaging a given area from a plurality of different positions as input, and generating digital surface model data expressing the surface of the given area in three-dimensional coordinates, an extracting operation for extracting candidates for flight obstacles that could conflict with a flight restriction surface from the images on the basis of the digital surface model data generated by the stereo matching processing operation, and a detecting operation for detecting the flight obstacles that conflict with the flight restriction surface from among the candidates for flight obstacles extracted by the obstacle candidate extracting operation.

### Advantageous Effects of Invention

According to the present invention, a flight obstacle extraction device, a flight obstacle extraction method, and a recording medium able to extract flight obstacles in detail with few man-hours can be provided.

### BRIEF DESCRIPTION OF DRAWINGS

FIG. 1 is a block diagram illustrating an exemplary configuration of a flight obstacle extraction device in accordance with an embodiment of the present invention.

FIG. 2 is a schematic diagram illustrating relationships among photographic ranges of a plurality of aerial images.

FIG. 3 is a schematic diagram illustrating relationships among photographic ranges of a plurality of aerial images.

FIG. 4 is a schematic diagram illustrating a central projection image.

FIG. 5 is a schematic diagram illustrating an orthographic image.

FIG. 6 is a flowchart illustrating exemplary operations of a flight obstacle extraction process in accordance with an embodiment.

FIG. 7 is a block diagram illustrating an exemplary physical configuration of a flight obstacle extraction device in accordance with an embodiment of the present invention.

FIG. 8 is a block diagram illustrating an exemplary configuration of a flight restriction surface check device of the related art.

### MODES FOR CARRYING OUT THE INVENTION

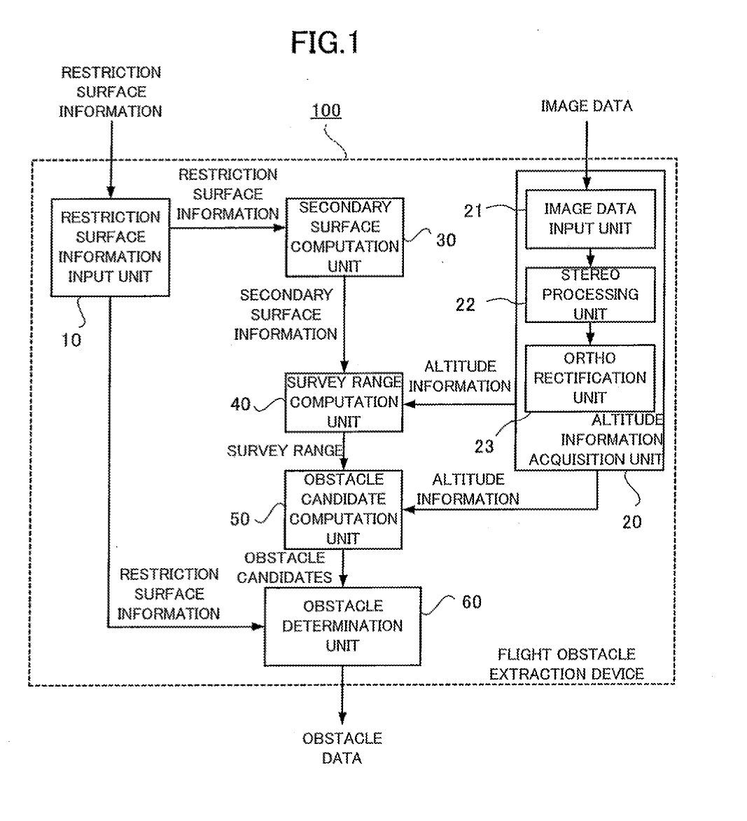

Hereinafter, modes for carrying out the present invention will be described with references to the drawings. FIG. 1 is a block diagram illustrating an exemplary configuration of a flight obstacle extraction device in accordance with an embodiment of the present invention. A flight obstacle extraction device 100 is realized by a general-purpose computer and a program, etc. executed thereon, for example. As illustrated in FIG. 1, the flight obstacle extraction device 100 is provided with a restriction surface information input unit 10, an altitude information acquisition unit 20, a secondary surface computation unit 30, a survey range computation unit 40, an obstacle candidate computation unit 50, and an obstacle determination unit 60. The altitude information acquisition unit 20 is provided with an image data input unit 21, a stereo processing unit 22, and an ortho rectification unit 23.

The restriction surface information input unit 10 is realized by a keyboard and mouse, etc. and a program using the same, for example. The restriction surface information input unit 10 inputs restriction surface information indicating relationships between positions and altitudes of a restriction surface.

The altitude information acquisition unit 20 is realized by a computer and a program, etc. executed thereon, for example. The altitude information acquisition unit 20 acquires altitude information indicating planar positions and altitudes of ground surfaces and building structures. The altitude information may be digital terrain model data (hereinafter called DTM data) indicating only planar positions and heights of ground surfaces, or digital surface model data (hereinafter called DSM data) that also includes planar positions and altitudes of building structures.

Herein, both DTM data and DSM data are data wherein altitude is expressed with a digital model (three-dimensional coordinates (X, Y, Z)). DTM data is also called DEM (Digital Elevation Model) data. Map data such as the digital maps of the Geospatial information Authority of Japan can be cited as an example of DTM data.

In contrast, DSM data is created from aerial photographs or other digital photographic images by conducting a stereo matching process or other automated measurement. More specifically, DSM data is elevation value data of building structures imaged in digital photographic images (for example, if a building is imaged, elevation value data of the building's rooftop is imaged).

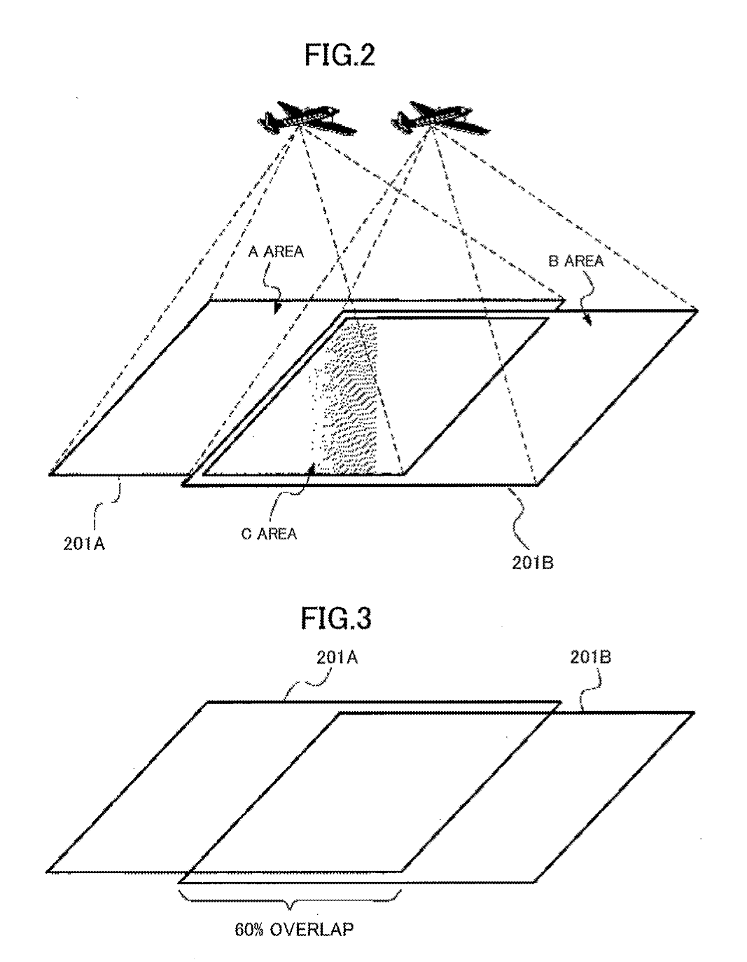

FIG. 2 and FIG. 3 are schematic diagrams illustrating relationships among projection ranges of a plurality of aerial images. The aerial images illustrated in FIG. 2 and FIG. 3 indicate positional relationships between ranges consecutively imaged from the air as aircraft fly by. The aerial images in FIG. 2 and FIG. 3 consist of an aerial photograph 201A in which an A area is imaged and an aerial photograph 201B in which a B area is imaged. Also, the aerial photograph 201A and the aerial photograph 201B are photographs in which an area overlapping 60% in the aircraft forward flight direction (a C area) is imaged. When such aerial images are imaged at a typical set of imaging conditions, i.e. a scanning resolution of 1200 dpi and at 1/5000 scale, the resolution on the ground surface of an aerial image becomes 12.5 cm/pixel, which is a higher resolution than laser data.

A stereo matching process is a process that, for a plurality of images imaged from different viewpoints, computes corresponding points in each image imaging the same point, and uses the parallax to compute the depth to a subject and the shape by the triangulation principle. In other words, the positions of corresponding features produce a given positional discrepancy (parallax) between an aerial photograph 201A and an aerial photograph 201B pair. For this reason, by measuring this positional discrepancy, a stereo matching process is able to compute altitude data having elevation values including the altitudes of feature surfaces.

Herein, various techniques can be used as the technique for conducting a stereo matching process, such as one that computes and associates typical feature values, or one that computes left/right image correlations. The technique used by a stereo matching process in the present embodiment is not limited. For example, a stereo matching process described in Examined Japanese Patent Application Publication No. H8-16930 may be used.

Usually, an image correlation of corresponding nearby sub-areas inside two images is taken, and the magnitude of the above positional discrepancy is measured from the position where the correlation coefficient is maximized. This image correlation is conducted over the entirety of the acquired images, and DSM data is generated by planarly measuring elevation values for individual lattice shapes at a fixed interval.

With respect to DSM data created by a stereo matching process, DSM data in the present embodiment is ortho DSM data that has been additionally subjected to ortho rectification. Herein, ortho rectification is a normalization process according to an orthogonal transform. However, an absolute orientation process is included in ortho rectification in the present embodiment. In other words, DSM data in the present embodiment refers to data obtained by the normalization and absolute orientation of data generated with a stereo matching process. Meanwhile, ortho rectification typically is either simple ortho that corrects topography only, or exact ortho that corrects even building structures. In the present embodiment, the latter exact ortho is indicated.

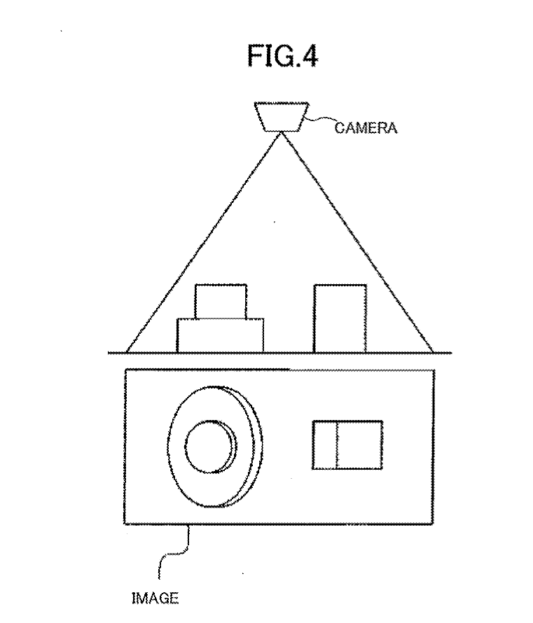

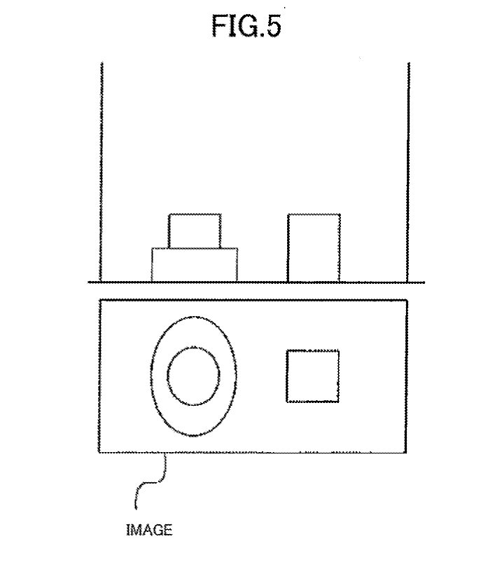

As illustrated in FIG. 4, in an image imaged by an ordinary camera, the subject appears slanted due to central projection and topographical unevenness, etc. More specifically, as illustrated in FIG. 5, DSM data in the present embodiment is generated by orthogonally projecting and absolutely orienting to a given plane a subject imaged at a tilt as illustrated in FIG. 4. In other words, data obtained by stereo matching processing is normalized and absolutely oriented in correspondence with an image, and DSM data is generated.

In ordinary DSM data, discrepancies from the correct positions occur at each point due to central projection and topographical unevenness, and since data with correct altitudes cannot be obtained, altitude comparisons are difficult. In contrast, since DSM data of the present embodiment (ortho DSM data) is orthogonally transformed as well as absolutely oriented, the data has correct positions consisting of latitudes, longitudes, and altitudes corresponding to DSM data. For this reason, altitudes in respective data can be mutually compared.

The image data input unit 21 of the altitude information acquisition unit 20 illustrated in FIG. 1 has functions for inputting image data, and inputs a plurality of imaged aerial image data. The stereo processing unit 22 has functions for generating DSM data, and conducts a stereo matching process on a plurality of aerial image data to generate DSM data.

The ortho rectification unit 23 conducts ortho rectification of DSM data in order to normalize the DSM data, and additionally has functions for conducting absolute orientation on ortho rectified DSM data. In other words, the ortho rectification unit 23 uses DSM data to orthogonally transform as well as conduct absolute orientation to generate corresponding ortho DSM data. Included in the ortho DSM data are altitude data having elevation values including the altitudes of feature surfaces, and latitude and longitude data according to absolute orientation.

In the above explanation, an example of latitude and longitude was described as the position data included in ortho DSM data. Position data in the present embodiment is not limited to latitude and longitude data, and may also be data of coordinate values expressed in another coordinate system. Also, an example of elevation values was described as the altitude data included in ortho DSM data. This altitude data is not limited to elevation values, and may also be values indicating relative altitudes from another standard.

The altitude information acquisition unit 20 supplies altitude information to a survey range computation unit 40 and an obstacle candidate computation unit 50. In the case of using DTM data only as the altitude information, it is not necessary to input image data and conduct a stereo matching process or ortho rectification. Rather, map data or other DTM data is input, and altitude information for respective points included therein is supplied to the survey range computation unit 40 and the obstacle candidate computation unit 50.

A secondary surface computation unit 30 is realized by a program, etc. executed on a CPU, using for example a CPU (Central Processing Unit), ROM (Read-Only Memory), RAM (Random-Access Memory), a hard disk drive, etc. as hardware resources. The secondary surface computation unit 30 computes secondary surface information from restriction surface information input into the restriction surface information input unit 10 according to separately-defined computations.

Herein, a secondary surface refers to a virtual restriction surface for computing a flight obstacle survey range. More specifically, a secondary surface refers to a plane obtained by moving the restriction surface in the vertical direction by a fixed altitude (20 m, for example). Also, secondary surface information refers to information indicating relationships between planar positions and altitudes of the secondary surface.

The survey range computation unit 40 is realized by a program, etc. executed on a CPU, using for example a CPU, ROM, RAM, a hard disk drive, etc. as hardware resources. The survey range computation unit 40 computes a flight obstacle survey range from altitude information input into the altitude information acquisition unit 20, and secondary surface information computed by the secondary surface computation unit 30. Herein, a survey range refers to the planar positions of building structures for which it is necessary to separately survey altitudes by on-site survey, etc.

More specifically, the survey range computation unit 40 compares the altitudes of ground surfaces and building structures indicated by altitude information to the altitude of a secondary surface indicated by secondary surface information, and computes the planar positions of ground surfaces and building structures that are higher than the secondary surface as the survey range.

The obstacle candidate computation unit 50 is realized by a program, etc. executed on a CPU, using for example a CPU, ROM, RAM, a hard disk drive, etc. as hardware resources. The obstacle candidate computation unit 50 computes candidates for flight obstacles inside a survey range computed by the survey range computation unit 40 (hereinafter also simply called “obstacle candidates”). Herein, an obstacle candidate refers to a ground surface or building structure with a possibility of being determined a flight obstacle.

More specifically, the obstacle candidate computation unit 50 displays a survey range computed by the survey range computation unit 40 on a screen such as an LCD (Liquid Crystal Display), for example. Also, the obstacle candidate computation unit 50 computes objects with planar positions inside the survey range from among the DSM data acquired by the altitude information acquisition unit 20 as obstacle candidates. Herein, the obstacle candidate computation unit 50 may also be configured to automatically extract building structure altitudes, etc. inside the survey range by conducting image processing, and compute them as obstacle candidates.

The obstacle determination unit 60 is realized by a program, etc. executed on a CPU, using for example a CPU, ROM, RAM, a hard disk drive, etc. as hardware resources. The obstacle determination unit 60 determines flight obstacles from obstacle candidates computed by the obstacle candidate computation unit 50 and restriction surface information input into the restriction surface information input unit 10, and outputs obstacle data indicating flight obstacles. Herein, a flight obstacle refers to a ground surface, building structure, etc. that is higher than a restriction surface. Furthermore, building structures include features (for example, buildings, utility poles, steel towers, etc.) and rooftop structures (fences, antenna, lightning rods, billboards, etc.).

More specifically, the obstacle determination unit 60 compares altitudes of building structures indicated by DSM data that have been computed as flight obstacle candidates by the obstacle candidate computation unit 50 to the altitude of a restriction surface indicating by restriction surface information, and determines building structures higher than the restriction surface to be flight obstacles.

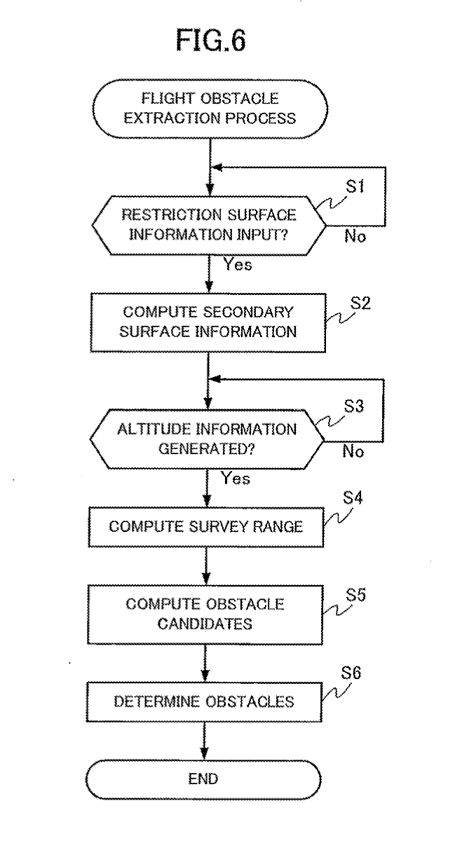

FIG. 6 is a flowchart illustrating exemplary operations of a flight obstacle extraction process in accordance with an embodiment. In this process, the restriction surface information input unit 10 first determines whether or not restriction surface information is being input (step S1), and stands by until restriction surface information is input (step S1: No).

In the case where restriction surface information was input by the processing in step S1 (step S1; Yes), the secondary surface computation unit 30 computes secondary surface information from the restriction surface information input into the restriction surface information input unit 10 (step S2).

After executing the processing in step S2, the flight obstacle extraction device 100 determines whether or not altitude information is being generated by the altitude information acquisition unit 20 (step S3), and stands by until altitude information is generated (step S3; No).

In the case where altitude information was generated by the processing in step S3 (step S3; Yes), the flight obstacle extraction device 100, in the survey range computation unit 40, computes a flight obstacle survey range from the altitude information input into the altitude information acquisition unit 20 and the secondary surface information computed by the processing in step S2 (step S4).

Subsequently, the obstacle candidate computation unit 50 computes obstacle candidates inside the flight obstacle survey range computed by the processing in step S4 (step S5).

Then, the obstacle determination unit 60 determines flight obstacles from the obstacle candidates computed by the processing in step S5 and the restriction surface information input into the restriction surface information input unit 10, outputs obstacle data indicating flight obstacles (step S6); and then ends the flight obstacle extraction process.

Hereinafter, specific examples of the operation of a flight obstacle extraction device 100 executing the above process will be given and explained.

First, operation of a flight obstacle extraction device 100 will be explained, taking by example the case where a plane obtained by moving 500 m vertically downward from a restriction surface is taken to be the secondary surface, since building structures with altitudes of 500 m or more do not ordinarily exist.

In this case, if restriction surface information is input into the restriction surface information input unit 10 (step S1; Yes), in the processing in step S2 the flight obstacle extraction device 100 computes secondary surface information by uniformly subtracting 500 m from the altitudes indicated by the restriction surface information. Thus, the secondary surface information indicates a secondary surface whose planar position is identical to the restriction surface, and whose altitude is 500 m lower than the restriction surface.

After that, if DTM data indicating only the planar positions and altitudes of ground surfaces is generated as altitude information (step S3; Yes), in the processing in step S4 the flight obstacle extraction device 100 compares the altitudes of ground surfaces indicated by the DTM data to the altitude of the secondary surface indicated by the secondary surface information, and computes the planar positions of ground surfaces higher than the secondary surface as the survey range.

Inside the survey range computed in this way, there is a possibility that building structures with altitudes less than 500 m will trespass the restriction surface. For this reason, it is necessary to separately survey the altitudes of building structures by on-site survey, etc., and input DSM data indicating those altitudes, etc. into the altitude information acquisition unit 20.

In contrast to this, outside the survey range, i.e. at the planar positions of ground surfaces lower than the secondary surface, it is clear that building structures trespassing the restriction surface do not exist. For this reason, it is not necessary to separately survey for the existence and altitudes of building structures or input DSM data into the altitude information acquisition unit 20.

Second, operation of a flight obstacle extraction device 100 will be explained, taking by example the case where a plane obtained by moving 20 m vertically downward from a restriction surface is taken to be the secondary surface, under the assumption that lightning rods or other rooftop structures with altitudes of 20 m or more do not ordinarily exist.

In this case, if restriction surface information is input into the restriction surface information input unit 10 (step S1; Yes), in the processing in step S2 the flight obstacle extraction device 100 computes secondary surface information by uniformly subtracting 20 in from the altitudes indicated by the restriction surface information. Thus, the secondary surface information indicates a secondary surface whose planar position is identical to the restriction surface, and whose altitude is 20 m lower than the restriction surface.

After that, if DSM data indicating only the planar positions and altitudes of ground surfaces is generated as altitude information (step S3; Yes), in the processing in step S4 the flight obstacle extraction device 100 compares the altitudes of ground surfaces indicated by the DSM data to the altitude of the secondary surface indicated by the secondary surface information, and computes the planar positions of ground surfaces higher than the secondary surface as the survey range.

Inside the survey range computed in this way, there is a possibility that rooftop structures with altitudes less than 20 m will trespass the restriction surface. For this reason, it is necessary to separately survey the altitudes of rooftop structures by on-site survey, etc., and input DSM data indicating those altitudes, etc. into the altitude information acquisition unit 20.

In contrast to this, outside the survey range, i.e. at the planar positions of ground surfaces lower than the secondary surface, it is clear that rooftop structures trespassing the restriction surface do not exist. For this reason, it is not necessary to separately survey for the existence and altitudes of building structures or input DSM data into the altitude information acquisition unit 20.

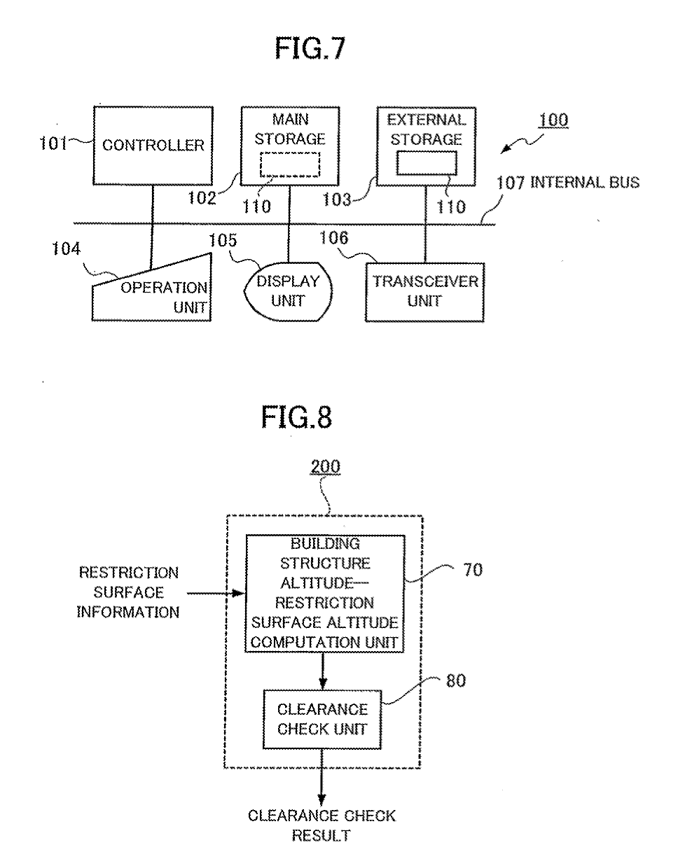

FIG. 7 is a block diagram illustrating an exemplary physical configuration of a flight obstacle extraction device in accordance with an embodiment of the present invention. As illustrated in FIG. 7, a flight obstacle extraction device 100 is provided with a controller 101, a main storage 102, an external storage 103, a operation unit 104, a display unit 105, and a transceiver unit 106. The main storage 102, external storage 103, operation unit 104, display unit 105, and transceiver unit 106 are each coupled to the controller 101 via an internal bus 107.

The controller 101 consists of a CPU (Central Processing Unit), etc., and executes processing of the flight obstacle extraction device 100 obeying a flight obstacle extraction program 110 stored in the external storage 103.

The main storage 102 consists of RAM (Random-Access Memory), etc., loads the flight obstacle extraction program 110 stored in the external storage 103, and is used as a work area for the controller 101.

The external storage 103 consists of non-volatile memory such as flash memory, a hard disk, DVD-RAM (Digital Versatile Disc Random-Access Memory), DVD-RW (Digital Versatile Disc ReWritable), and stores in advance the flight obstacle extraction program 110 for causing the controller 101 to conduct the processing discussed above. Also, the external storage 103, obeying instructions from the controller 101, supplies data stored by the flight obstacle extraction program 110 to the controller 101 and stores data supplied from the controller 101.

The operation unit 104 consists of a keyboard and a pointing device, etc. such as a mouse, and an interface device that couples the keyboard and pointing device, etc. to the internal bus 107. Operator instructions are input via the operation unit 104.

The display unit 105 consists of a CRT (Cathode Ray Tube) or LCD (Liquid Crystal Display), etc., and displays processing results of the flight obstacle extraction device 100. The display unit 105 may also consist of a printer or speakers, etc. and other interface devices in some cases.

The transceiver unit 106 consists of communication devices and a serial interface or LAN (Local Area Network) interface coupled thereto. The transceiver unit 106 couples with peripheral equipment via a network (not illustrated), and sends and receives image data, etc.

The processing of the restriction surface information input unit 10, altitude information acquisition unit 20, secondary surface computation unit 30, survey range computation unit 40, obstacle candidate computation unit 50, and obstacle determination unit 60 in FIG. 1 is executed by processing the flight obstacle extraction program 110 using the controller 101, main storage 102, external storage 103, operation unit 104, display unit 105, transceiver unit 106, etc. as resources.

As described above, a flight obstacle extraction device 100 in accordance with the present embodiment limits a survey range from a secondary surface computed from a restriction surface and DTM data or DSM. data. By merely conducting a separate survey of the altitudes of building structures by on-site survey, etc. and inputting DSM data indicating such altitudes, etc. into the altitude information acquisition unit 20 inside this survey range only, flight obstacles can be determined from the altitudes indicated by the DSM data and the restriction surface.

Thus, it becomes possible for the flight obstacle extraction device 100 to omit or reduce the surveying by on-site survey, etc. of the altitudes of building structures that clearly do not trespass the restriction surface, as well as the inputting of DSM data indicating such altitudes into the altitude information acquisition unit 20. For this reason, the number of man-hours can be reduced, while in addition, flight obstacles can be extracted in detail even with few man-hours.

Also, error is typically included in altitudes indicating by DSM data. For this reason, the flight obstacle extraction device 100 sets a secondary surface moved vertically downward with consideration for the range of anticipated error. By using this secondary surface to compute a flight obstacle survey range and additionally to compute obstacle candidates inside the survey range, obstacle candidates can be extracted with fewer overlooked obstacles.

Furthermore, although the computation of obstacle candidates requires altitudes that include not only the altitudes of building structures but also those of rooftop structures such as lightning rods, it is difficult to acquire DSM data that accurately indicates altitudes for rooftop structures such as lightning rods. For this reason, the flight obstacle extraction device 100 sets a secondary surface moved vertically downward by at least the maximum altitude of anticipated rooftop structures. By using this secondary surface to compute a flight obstacle survey range and additionally to compute obstacle candidates inside the survey range, obstacle candidates can be extracted with fewer overlooked obstacles.

Moreover, the flight obstacle extraction device 100 computes a flight obstacle survey range and additionally computes obstacle candidates inside the survey range by using DSM data created by conducting automated measurement such as a stereo process from aerial photographs or other digital photographic images. For this reason, the operator is able to accurately interpret the planar positions of building structures computed as obstacle candidates by visually interpreting the aerial photographs or other digital photographic images in stereoscopy.

As a result, the operator becomes able to accurately overlay the interpreted results. i.e. the DSM data and the digital photographic images onto map data by using aerial triangulation results, and becomes able to easily specify the DSM data of building structures conflicting with the restriction surface or the secondary surface on the map indicated by the map data. For this reason, the flight obstacle extraction device 100 can simplify the verification of the results of interpretation conducted on the basis of on-site survey, etc.

However, the present invention is not limited to the above-described embodiment, and various modifications and applications are possible. Hereinafter, a modification of the above-described embodiment that is applicable to the present invention will be described.

An aerial image in the present embodiment is an image generated by digitally converting aerial photographs exemplified by the aerial photograph 201A and the aerial photograph 201B, but this is merely an example of an image to which the present invention is applied. Consequently, an image to which the present invention is applied is not limited to aerial images, and may also be an image given by a digitized satellite photograph, a digital image imaged with a conventional digital camera, or a digital image obtained by scanning and digitizing an analog photograph imaged with analog camera, for example.

Herein, although latitude and longitude data was discussed as data included in DSM data (ortho DSM data) in the present embodiment, such data is not limited to latitude and longitude data, and may also be data of coordinate values expressed in another coordinate system.

Furthermore, although elevation values were discussed as data having altitude data included in DSM data (ortho DSM data) in the present embodiment, such data having altitude data is not limited to elevation values, and may also be values indicating relative altitudes from another standard.

It should be appreciated the present embodiment disclosed herein is exemplary in all respects and not limited. The scope of the present invention is expressed by the scope of the claims rather than the above description, and all modifications are intended to be included therein insofar as they are within the scope of the claims or the equivalents thereof.

Otherwise, the above hardware configuration and flowchart are exemplary, and arbitrary modifications and revisions are possible.

Extraction of flight obstacles in accordance with the present embodiment is not limited to specialized hardware, and can also be realized by an ordinary computer. More specifically, in the above-described embodiment, a program was described as being stored in advance in ROM, etc. However, a program for causing the above-described processing operations to be executed may also be stored and distributed on a computer-readable recording medium such as a flexible disk, an MO (Magneto-Optical disk), CD-ROM (Compact Disk Read-Only Memory), DVD (Digital Versatile Disk), or BD (Blu-ray Disk), and it may be configured such that the above operations are made to be executed on a computer by installing the program onto a computer.

Also, it may be configured such that the program is stored on a disk device, etc. included in a server device on a communication network such as the Internet, superimposed onto a carrier wave, and downloaded, etc. onto a computer, for example. Furthermore, the above-described processes can also be achieved by launching and executing the program while transferring it via a communication network.

Additionally, in cases where the above-described functions are realized by contribution of an OS (Operating System) or by the cooperation of an OS and an application, just the parts other than the OS may be stored and distributed on a medium or downloaded, etc. onto a computer.

The present application is based on Japanese Patent Application No. 2009-38650 filed on Feb. 20, 2009. The specification, the scope of the claims, and all drawings in Japanese Patent Application No. 2009-38650 are hereby incorporated into the present specification by reference.

### Reference Signs List

10: restriction surface information input unit

20: altitude information acquisition unit

21: image data input unit

22: stereo processing unit

23: ortho rectification unit

40: survey range computation unit

50: obstacle candidate computation unit

60: obstacle determination unit

100: flight obstacle extraction device

101: controller

102: main storage

103: external storage

104: operation unit

105: display unit

106: transceiver unit

107: internal bus

110: flight obstacle extraction program

1-7. (canceled)

8. A flight obstacle extraction device, comprising:
setting means for setting a secondary surface obtained by moving a flight restriction surface vertically by a given altitude;
stereo matching processing means for taking a plurality of images imaging a given area from a plurality of different positions as input, and generating digital surface model data expressing the surface of the given area in three-dimensional coordinates;
extracting means for extracting candidates for flight obstacles that could conflict with the flight restriction surface from the images on the basis of the digital surface model data generated by the stereo matching processing means; and
detecting means for detecting the flight obstacles that conflict with the flight restriction surface from among the candidates for flight obstacles extracted by the obstacle candidate extracting means;
wherein
the extracting means extracts ground surfaces or building structures on features that exceed the secondary surface set by the setting means as the candidates for flight obstacles.

9. The flight obstacle extraction device according to claim 8, wherein
the setting means sets the secondary surface by moving the flight restriction surface vertically by an upper limit value anticipated for the altitudes of the building structures on ground surfaces, and
the extracting means extracts building structures on ground surfaces whose altitudes indicated by digital terrain model data exceed the altitude of the secondary surface as the candidates for flight obstacles.

10. The flight obstacle extraction device according to claim 8, wherein
the setting means sets the secondary surface by moving the flight restriction surface vertically by an upper limit value anticipated for the altitudes of the building structures on features, and
the extracting means extracts features whose altitudes indicated by the digital surface model data exceed the altitude of the secondary surface as the candidates for flight obstacles.

11. A flight obstacle extraction method conducted by a flight obstacle extraction device that detects flight obstacles that could conflict with a flight restriction surface, the flight obstacle extraction method comprising:
a setting step for setting a secondary surface obtained by moving a flight restriction surface vertically by a given altitude;
a stereo matching processing step for taking a plurality of images imaging a given area from a plurality of different positions as input, and generating digital surface model data expressing the surface of the given area in three-dimensional coordinates;
an extracting step for extracting candidates for flight obstacles that could conflict with a flight restriction surface from the images on the basis of the digital surface model data generated by the stereo matching processing step; and
a detecting step for detecting the flight obstacles that conflict with the flight restriction surface from among the candidates for flight obstacles extracted by the extracting step;
wherein
the extracting step extracts ground surfaces or building structures on features that exceed the secondary surface set by the setting means as the candidates for flight obstacles.

12. A computer-readable non-transitory tangible recording medium having recorded thereon a program for causing a computer to execute:
a setting operation for setting a secondary surface obtained by moving a flight restriction surface vertically by a given altitude;
a stereo matching processing operation for taking a plurality of images imaging a given area from a plurality of different positions as input, and generating digital surface model data expressing the surface of the given area in three-dimensional coordinates;
an extracting operation for extracting candidates for flight obstacles that could conflict with a flight restriction surface from the images on the basis of the digital surface model data generated by the stereo matching processing operation; and
a detecting step for detecting the flight obstacles that conflict with the flight restriction surface from among the candidates for flight obstacles extracted by the extracting operation;
wherein
the extracting operation extracts ground surfaces or building structures on features that exceed the secondary surface set by the setting means as the candidates for flight obstacles.

13. The flight obstacle extraction device according to claim 9, wherein the setting means sets the secondary surface by moving the flight restriction surface vertically by an upper limit value anticipated for the altitudes of the building structures on features, and
the extracting means extracts features whose altitudes indicated by the digital surface model data exceed the altitude of the secondary surface as the candidates for flight obstacles.
